(19) United States
(12) Patent Application Publication
(10) Pub. No.: US 2003/0110088 A1
(43) Pub. Date: Jun. 12, 2003

(54) Method and system for returning goods and tracking reasons for return of goods

(76) Inventors: Michael B. Starmer, Louisville, KY (US); Jon Timmons, Louisville, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/013,599

(22) Filed: Dec. 11, 2001

(51) Int. Cl. G06F 17/60

(52) U.S. Cl. 705/26

(57) ABSTRACT

A computerized method for authorizing return of goods and comparing returns of similar goods, the method comprising providing information identifying a good being returned, providing information identifying a condition of and a reason for a good being returned, providing an interface device configured for a customer to enter the information identifying a good being returned and the information identifying a condition of and a reason for a good being returned, entering the information identifying a good being returned and the information identifying a condition of and a reason for a good being returned into the interface device with the interface device, providing a processor remote from the interface device, transmitting the information identifying a good being returned and the information identifying a condition of and a reason for a good being returned from the interface device to the processor over an electronic network system, storing the information identifying a good being returned and the information identifying a condition of and a reason for a good being returned in a memory device, with the processor, determining whether a good qualifies for return based on the information identifying the good being returned, if the good qualifies for return, authorizing a return of the good, providing an input/output device to retrieve and view an authorization message, providing a database comprising the information about prior returned goods, with the processor, comparing the information identifying a good being returned and the information identifying a condition of and a reason for a good being returned with prior collected information about similar goods to determine whether a trend exists as to why similar goods are returned, and storing the trend results in the database.

### BACKGROUND OF THE INVENTION

The present invention relates generally to electronic commerce (E-commerce) system and techniques, and more particularly, to computerized method and system for authorizing product returns and tracking reasons for returns to assist reduce future returns.

The quality of manufactured or supplied goods is an integral concern of customers when deciding on a product brand. Customers tend to make purchasing decisions based, at least in part, upon reports about other customers' satisfaction with a particular good or product. If a manufacturer or supplier develops an unacceptable record of having many goods return, this type of information can result in reduced future sales.

In addition to having concerns about consumer perception, the costs associated with handling the return of goods are expensive. There are costs associated with adequately tracking the return, delivering the goods back to the manufacturer or supplier, verifying that a return is not fraudulent. Additionally, several individuals at a point of sale are involved with returning goods. On a supplier's side of a return, at least one individual is involved with coordinating and verifying whether a return is authorized. As an end result, the costs involved are ultimately passed back to consumers by the way of increased prices for goods.

Thus, it is desirable to reduce or minimize costs associated with returning goods. It is very important for suppliers of goods, such as the assignee of the present invention, to have computerized tools that accurately and inexpensively allow for implementing techniques that are conducive to systematically determining whether a product is acceptable for being returned. Having this type of system will not only reduce the number of individuals involved with returning a good, but it will also help reduce fraudulent returns.

Sometimes trends develop as to why a particular good is returned more often than other goods. The reason for a high number of returns may not be readily identified until a supplier notices a problem by an increase of returns. Once noticed, the supplier may either think nothing of the increase and continue doing business as usual until the number of returns increase, or conduct an investigation to determine a possible cause for the high number of returns. Either approach will take time and will inevitably be costly to the supplier. If an investigation is started, several individuals may be involved where these individuals are attempting to determine trends based on shipping companies used, customers delivered too, and regions of the country the products are shipped. In time, they may discover a trend. This type of investigation could result in such trend results showing that either a product is not constructed soundly enough, a shipping company is improperly handling a line of goods, or a customer is improperly handling a line of goods.

Though a manual investigation may eventually reach a conclusion explaining a high number of returns, the time taken for the investigation and the ultimate costs for the investigation could be high. Moreover, present techniques are believed not to provide any computer-processable business rules that would allow for objectively and automatically escalating the order to the supervisory personnel to avoid creating a festering aged-order condition. Thus, it is desirable to provide method and system that takes advantage of the speed and accuracy of computers for processing and communicating information that allows for accurately and inexpensively solving and efficiently handling the above-discussed issues.

### SUMMARY OF THE INVENTION

Towards this end, there is a need for a computerized method for authorizing return of goods and comparing returns of similar goods to determine whether a trend exists for the return of goods. The method comprises providing information identifying a good being returned, providing information identifying a condition of and a reason for a good being returned, and providing an interface device configured for a customer to enter the information identifying a good being returned and the information identifying a condition of and a reason for a good being returned. The method further comprises entering the information identifying a good being returned and the information identifying a condition of and a reason for a good being returned into the interface device with the interface device, and providing a processor remote from the interface device. The information identifying a good being returned and the information identifying a condition of and a reason for a good being returned is transmitted from the interface device to the processor over an electronic network system. The information identifying a good being returned and the information identifying a condition of and a reason for a good being returned is stored in a memory device. With the processor, a determination is made as to whether a good qualifies for return based on the information identifying the good being returned. If the good qualifies for return, authorizing a return of the good is given. The method also comprises providing an input/output device to retrieve and view an authorization message, and providing a database comprising the information about prior returned goods. With the processor, the information identifying a good being returned and the information identifying a condition of and a reason for a good being returned is compared with prior collected information about similar goods to determine whether a trend exists as to why similar goods are returned. The trend results are stored in the database.

There is also need for a computerized system for managing returns of goods and collecting and tracking trends identifying reasons for returns of like goods. The system comprises information identifying a good being returned including a reason for returning the good and a condition of the good, an interface medium for entering the information into the system, a database containing the information based on previous returned like goods, and a processor. The processor is operable to determine whether a good qualifies for return based on the information identifying the good being returned, and to compare the information of a good with the information based on previous returned like goods located in the database to determine whether a trend exists as to why like good are returned. The system also comprises an input/output device to display a message identifying whether a good qualifies for return.

### BRIEF DESCRIPTION OF THE DRAWINGS

The features and advantages of the present invention will become apparent from the following detailed description of the invention when read with the accompanying drawings in which:

FIG. 1 is an exemplary illustration of a computerized system in one embodiment of the present invention;

FIG. 2 is an exemplary screen display of how specific information about a good can be entered;

FIG. 3 is an exemplary screen display of how information regarding a condition of a good is entered;

FIG. 4 is an exemplary screen display of a return authorization

FIG. 5 is an exemplary screen display of how identifying a reason for a return is entered;

FIG. 6 is an exemplary screen display of providing information about fees associated with returning a product;

FIG. 7 is an exemplary screen display of changing a return carrier;

FIG. 8 is an exemplary screen display of a final confirmation screen;

FIG. 9 is a flowchart of an exemplary example of the present invention; and

FIG. 10 is a flowchart of an exemplary example of the present invention.

### DETAILED DESCRIPTION OF THE INVENTION

Before describing in detail various aspects of the present invention, it should be observed that the present invention broadly comprises a novel combination of processing steps/action and or/hardware/software configured to quickly and reliably meet the servicing needs of businesses trying to facilitate returning goods. Accordingly, these processing steps/actions and hardware/software components have been represented by generic processes and elements in the drawings, showing only those specific details that are pertinent to the present invention, so as not to obscure the disclosure with structural details or operational interrelationships that will be readily apparent to those skilled in the art having the benefit of the description herein.

FIG. 1 is an exemplary illustration of a computerized system in one embodiment of the present invention. An interface medium 10, or device, is provided for entering information into the system. Examples of the interface device 10 are either a computer terminal or a wireless device such as a palm computer. The interface device 10 is in communication with a processor 12, by way of a computer network system such as the Internet 15. In one exemplary embodiment, the interface device 10 is located at a first facility 20 or location, such as a customer's facility, and the processor 12 is located at a second facility 22 or location, such as a manufacturer's facility. Also residing at the second location 22 with the processor 12 is a memory device 17 and a database 19.

As one skilled in the art will recognize, the memory device 17 and database 19 do not have to be located at a same location as the processor 12. These components 17, 19 can reside at the first location, at a third location, or all three components 12, 17, 19 can all reside at remote locations from each other where remote means that the components are not directly connected to each other. In other words, the components 12, 17, 19 may all reside in the same facility but are connected via an electronic, or computer, network 15. Likewise, one skilled in the art will recognize that the interface device 10 can be at a plurality of locations, as long as it is remote from the processor 12. Towards this end, the use of first location and second location is not provided to suggest a limitation as to a given physical location. These terms are provided simply as an exemplary illustration that components 10, 12, 17, 19 are in remote locations from the other components.

The memory device 17 is used to store information sent from the interface device 10 to the processor 12. The processor 12 is capable of evaluating the information sent from the interface device 10 to determine whether a good meets a predefined criterion to be returned. For example, the processor 12 would be able to determine whether a good has been returned within a specified return period.

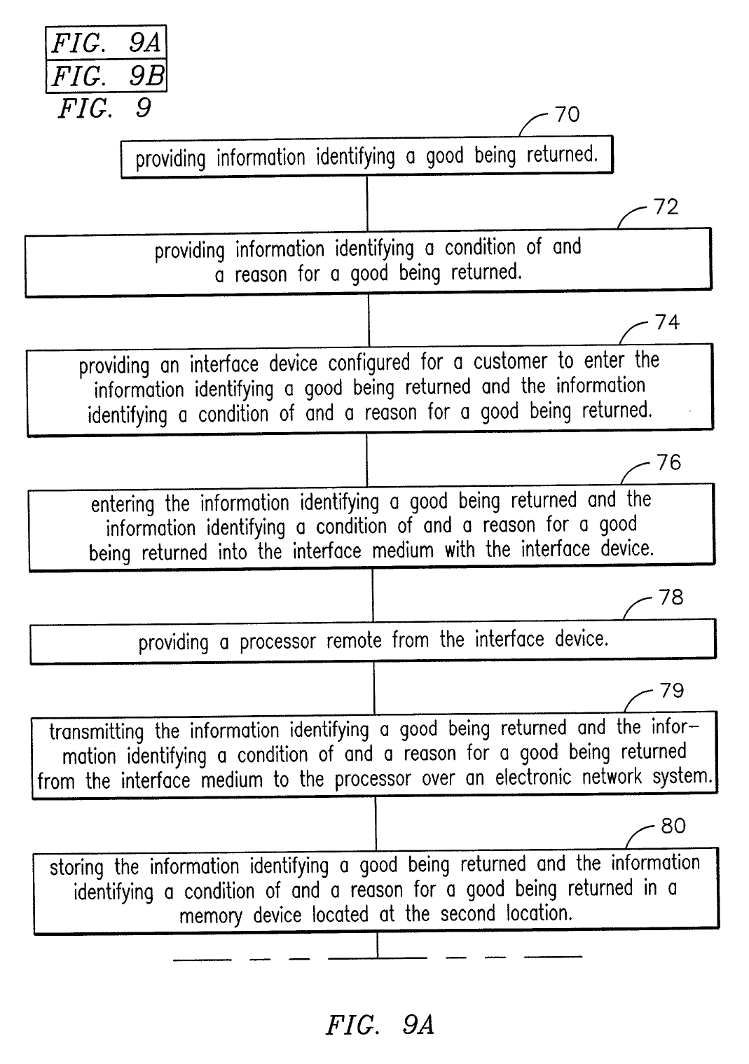

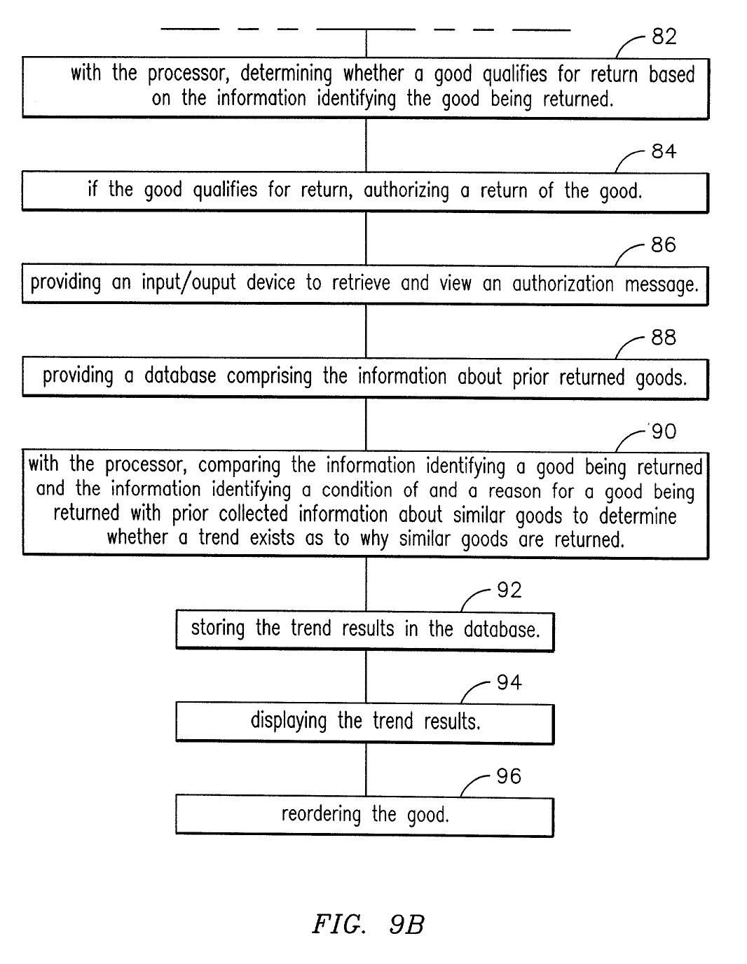

As further illustrated in FIGS. 9-10, the processor 12 is also operable to compare information regarding reasons for the return of a good as well the condition of the good or the good's container with prior information received on previously returned like goods, and then determine whether a trend exists as to why like goods are being returned. If the processor 12 determines that a good meets the criteria to be returned, this authorization will be displayed back at the first location 20 on an input/output device 25, which can be part of the interface device 10.

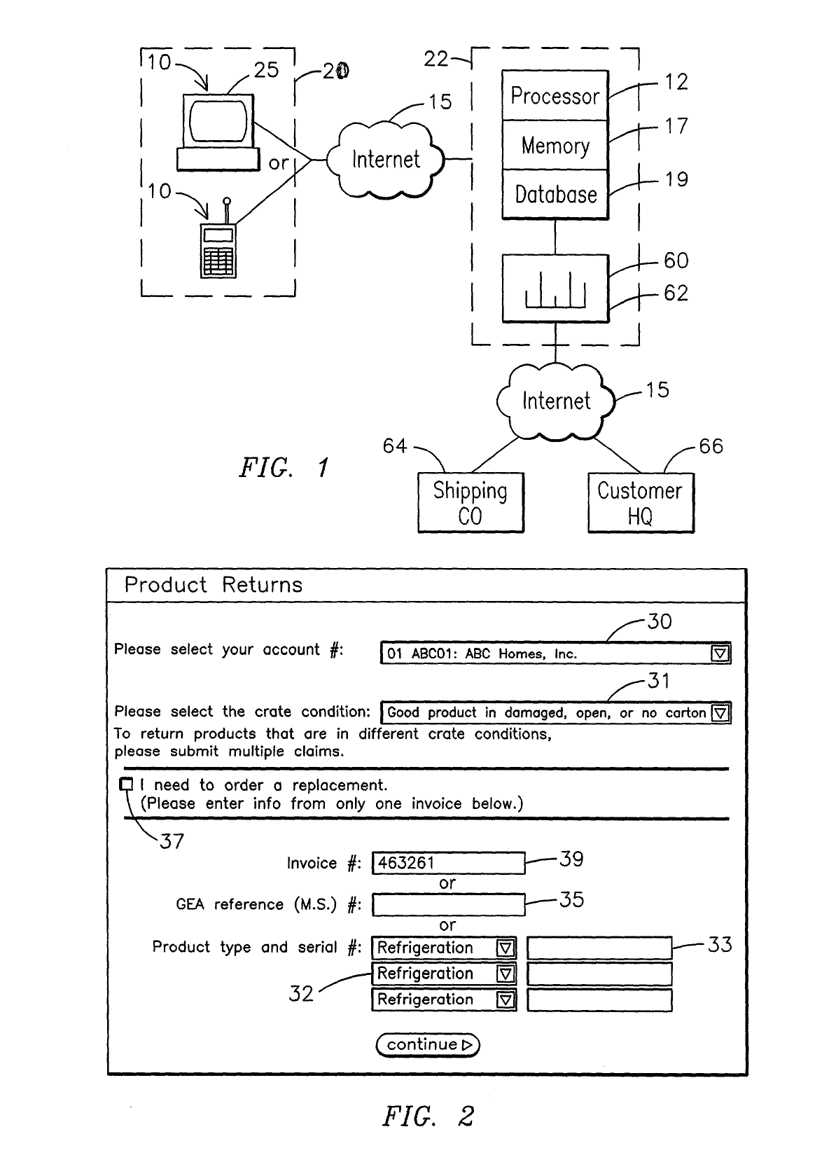

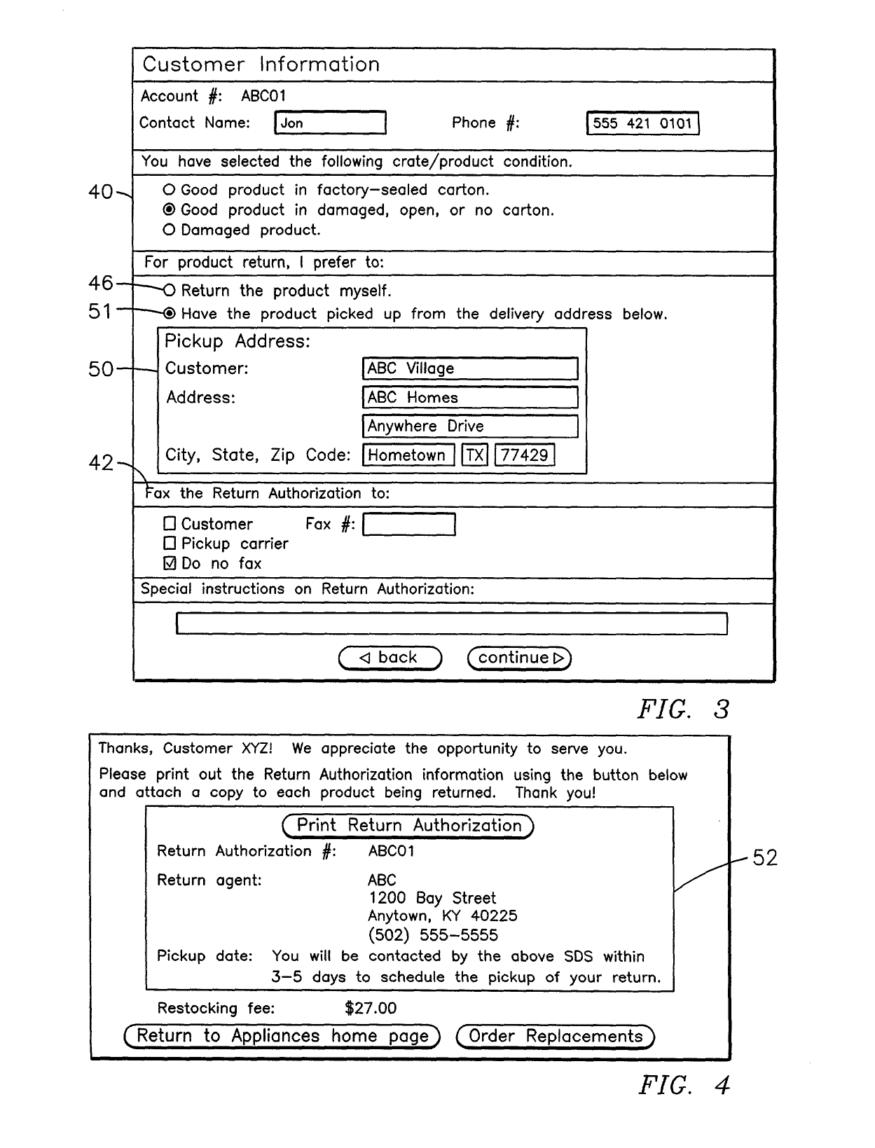

FIGS. 2 through 8 are exemplary screen displays that a user at the first location 20 would see on the interface device 10. One skilled in the art will realize that the functions illustrated in these screens are not dependent to a certain screen and can be placed on any screen display. As illustrated in FIG. 2, after entering an account number 30, which would be specific to a user or customer, the user or customer can select a condition of a crate, or shipping package, 31 of the good or product. The user or customer also has an option to order a replacement for the returned good 37. If a reorder of a good is desired, the system provides a reorder link 37 that the user or customer can select to an order system (not shown). The user or customer has several options to identify the good being returned. The user or customer can select a product line 32, such as a refrigerator or dishwasher, and the serial number 33 for the respective good. In other embodiments, the user can enter the master shipping number 35, the purchase order number (not shown) and/or the invoice number 39. All of these embodiments are examples of information identifying a good that is being returned. With respect to a condition of the good, or its shipping container or package, FIG. 3 illustrates where a user can either select or change the crate condition 40 previously selected as illustrated in FIG. 2. On this screen, the user or customer can also identify how the product is to be returned by selecting either to return the good itself 46 or having the manufacturer arrange the return of the product 51. Other information included on this screen includes the pickup address 50. In one embodiment as also illustrated by FIG. 3, a customer identifies how a return authorization is to be received from the manufacturer 42. As further illustrated, the return authorization can be faxed to either the customer or a pickup carrier, or not faxed. In another embodiment, the return authorization is emailed to a customer or electronically transmitted to the customer. FIG. 4 is an exemplary illustration of the authorization 52 electronically transmitted from the processor back to the customer authorizing the return of the product. In an exemplary embodiment, an authorization certificate 52 is printed once received, and is included with the product or good when it is returned to a manufacturer.

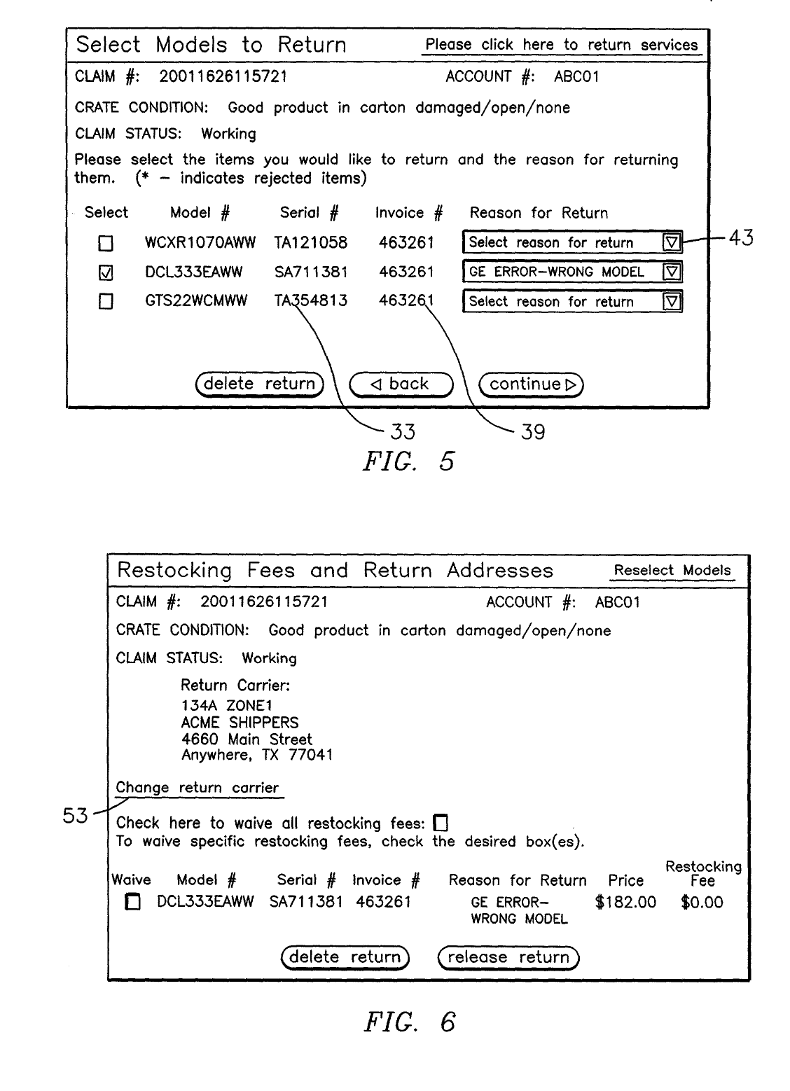

FIG. 5 is an exemplary illustration of where a customer can select a reason for returning a good 43. Specifically, the customer will provide information identifying a reason for returning the good. The customer will have an opportunity to select the reason for a return after the identity 32, 33, 35, 39 of the good is entered.

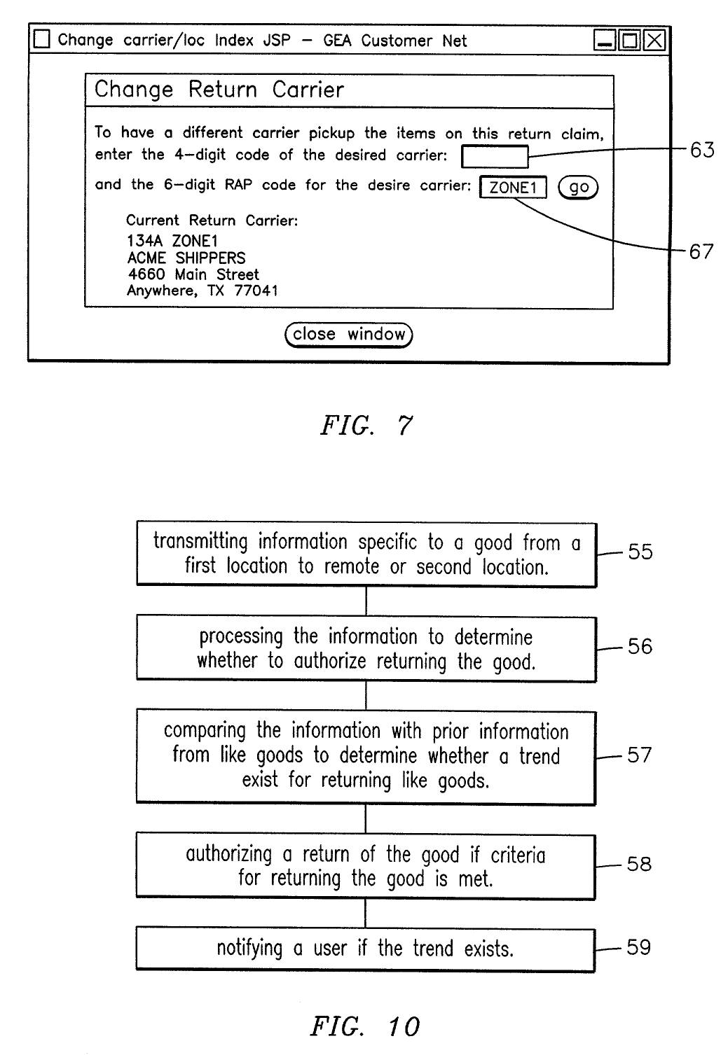

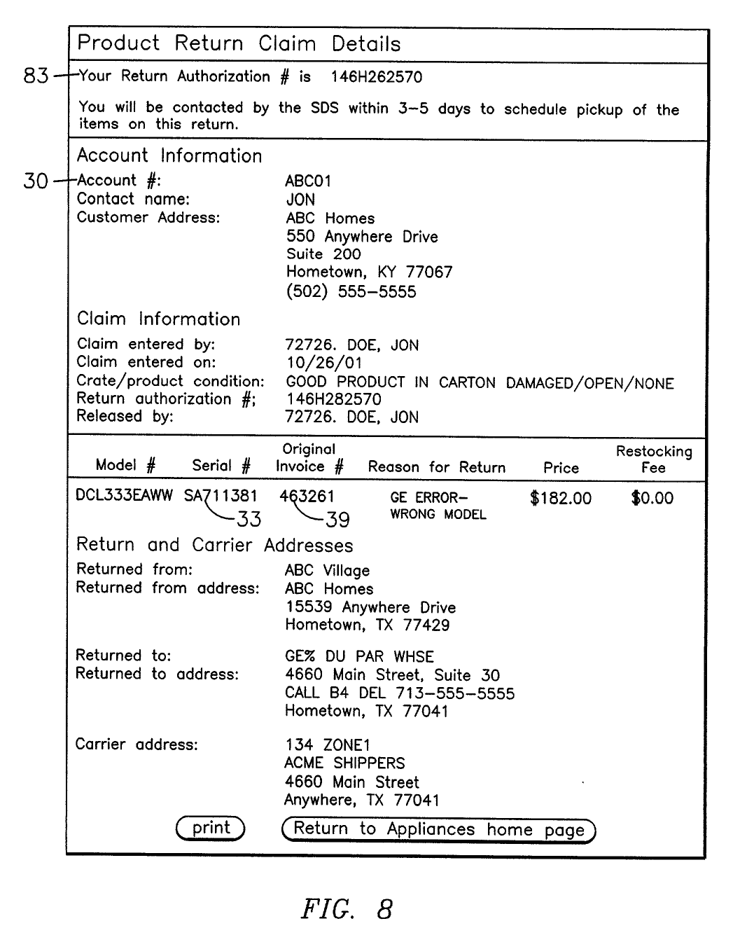

FIG. 6 is an exemplary illustration of a screen that provides the customer information about fees that may be associated with returning a good, such as restocking fees. This screen also identifies the return carrier and allows the customer to change the return carrier 53. If the customer decides to change the return carrier, FIG. 7 is an exemplary illustration of a screen where the customer can change the return carrier. In one embodiment, the customer will enter a code that identifies the desired carrier 63, such as a four-digit code. The customer will also enter a code identifying a desired zone 67, such as a six digit RAP code which is a code that is tied to carrier codes and contain rates a manufacturer pays carriers and rates the manufacturer charges its customers. FIG. 8 is an exemplary illustration of a final confirmation screen. In addition to identifying the customer, an authorization number 83 is provided.

As further illustrated in FIG. 1, trend results 60 calculated by the processor are displayed to a user at the second location 22, at a location preferred by the user or manufacturer, or a location remote from the interface device 10. This information can either be displayed via a second output device 62 such as a computer terminal or a palm computer. In another embodiment, and as is further illustrated in FIG. 1, the trend results 60 are communicated via an electronic, or computer, network 15 to a shipping company 64 responsible for shipping a specific good and/or to a customer 66 who purchases a specific type of goods. By doing this, all three business entities—the manufacturer, the shipping company and customer—can view the trend results to see whether a high percentage of returns are a result of an activity performed on any of the business entities' behalf. For example, if a shipping company ships a specific good to one region of the country, and a high percentage of these goods are being returned wherein the good and its respective container is damaged, the trend results might suggest that the shipping company is at fault because like, or similar, goods shipped to other regions of the country using a different shipper do not result in as high a number of returns. Conversely, if the trend results show a high number of returns from a specific store in a specific region, these results may suggest that this specific store is handling the goods improperly. Finally, if a plurality of goods from various regions are being returned for similar reasons such as, in the case of a refrigerator, for broken door handles, the manufacturer will be able to assess that either the shipping container is not sturdy enough or that the manufacturing of the handles needs to be improved. In one embodiment, using the trend results 60, business entities could develop contracts in which the entity identified as being the culprit for a high number of returns could be assessed with the costs for returning the items to the manufacturer.

FIG. 9 is a flowchart of an exemplary example of the present invention. As illustrated in this flowchart, the method comprises providing information that identifies a good being returned, Step 70. As previously discussed, this information could comprise a product line identification for the good, such as dishwasher, and its serial number. Also being provided is information identifying the condition of a good to be returned as well as a reason for returning the good, Step 72. As previously discussed, an interface device is also provided, step 74. This interface device is configured for a customer or user to enter the information identifying the good as well as the information identifying the condition of and reason for returning the good. The information is entered with the interface device, Step 76. At a second, or remote location, a processor resides that is remote from the interface device, Step 78. The information is transmitted over an electronic, or computer, network system 15, such as the Internet, from the interface device to the processor, Step 79.

In one exemplary embodiment, the ubiquitous Internet constitutes one convenient medium for communicating and accessing a central depository or database including the processor and screens, such as may be provided in a Web site operated and managed by the assignee of the present invention. It will be appreciated, however, that the Internet is just one example of a communication network that would allow users to conveniently access data and communicate between remote locations, since other communication networks could be used depending on the requirements of any given application, e.g., Intranets, Wide Area Networks, Local Area Networks, Wireless Networks, Cellular Network, satellite-based networks, computer networks, electronic networks, etc.

Referring back to FIG. 9, the information is stored in a memory device, Step 80. Using the processor, a determination is made with respect to whether the good qualifies for return, Step 82. If the good does qualify for return, an authorization notice is granted and is sent to the customer, Step 84. This information is accessible to a customer either via an input/output device, such as a computer or a palm computer, Step 86. Though not shown, the authorization notice is delivered using another delivery method such as facsimile or mail. A database, which comprises information about prior returned goods is also provided, Step 88. This information in the database includes an identification of the goods as well as the condition and the reason for the goods being returned. With the processor, a comparison is made with the recent returned goods and the prior collected information about similar goods to determine whether a trend exists as to why similar goods are being returned, Step 90. The results of this comparison are stored in the database, Step 92. In one embodiment, the results are displayed for a viewing, Step 94. If desired, once authorization for a return is granted, a customer can then re-order the good Step 96.

FIG. 10 is another flowchart of an exemplary example of the present invention. This flowchart illustrates transmitting information that is specific to a good from a first location to a second, or remote location, Step 55. The information is then processed to determine whether to authorize returning the good, Step 56. The information is then compared with prior information from like goods to determine whether a trend exists for returning the goods, Step 57. If the goods meet the criteria for returning, an authorization for returning the goods is then provided, Step 58. If a trend does exist, a user is then notified of the trend, Step 59.

The present invention can be embodied in the form of computer-implemented processes and apparatus for practicing those processes. The present invention can also be embodied in the form of computer program code including computer-readable instructions embodied in tangible media, such as floppy disks, CD-ROMS, DVDs, hard drives, or any other computer-readable storage medium, wherein when the computer program code is loaded into and executed by a computer(s), the computer(s) becomes an apparatus for practicing the invention. When implemented on a computer(s), the computer program code segments configure the computer(s) to create specific logic circuits or processing modules.

While the invention has been shown and described in what is presently considered to be a preferred embodiment, many variations and modifications will become apparent to those skilled in the art. Accordingly, it is intended that the invention not be limited to the specific illustrative embodiment, but be interpreted with the full spirit and scope of the appended claims.

What is claimed is:

1. A computerized method for authorizing return of goods and comparing returns of similar goods, said method comprising:
providing information identifying a good being returned;
providing information identifying a condition of and a reason for a good being returned;
providing an interface device configured for a customer to enter said information identifying a good being returned and said information identifying a condition of and a reason for a good being returned;
entering said information identifying a good being returned and said information identifying a condition of and a reason for a good being returned into said interface device with said interface device;
providing a processor remote from said interface device;
transmitting said information identifying a good being returned and said information identifying a condition of and a reason for a good being returned from said interface device to said processor over an electronic network system;
storing said information identifying a good being returned and said information identifying a condition of and a reason for a good being returned in a memory device;
with said processor, determining whether a good qualifies for return based on said information identifying said good being returned;
if said good qualifies for return, authorizing a return of said good;
providing an input/output device to retrieve and view an authorization message;
providing a database comprising said information about prior returned goods;
with said processor, comparing said information identifying a good being returned and said information identifying a condition of and a reason for a good being returned with prior collected information about similar goods to determine whether a trend exists as to why similar goods are returned;
storing said trend results in said database.

2. The method of claim 1 further comprising displaying said trend results.

3. The method of claim 1 further comprising reordering said good.

4. The method of claim 1 further comprising determining how to return said good to a manufacturer.

5. The method of claim 4 further comprising determining a cost for returning said good.

6. The method of claim 1 further comprising assessing costs of returns to an entity based on said trend results.

7. The method of claim 6 wherein said trend results identify a shipper is responsible for a high number of returns.

8. The method of claim 6 wherein said trend results identify that a manufacture is responsible for a high number of returns.

9. The method of claim 6 wherein said trend results identify a customer is responsible for a high number of returns.

10. The method of claim 2 further comprising displaying said trend results for a shipping company to view.

11. The method of claim 2 further comprising displaying said trend results for a customer to view.

12. The method of claim 2 further comprising displaying said trend results for a manufacturer to view.

13. A computerized method for authorizing return of goods from a first location to remote location and tracking and comparing why a return of a specific good occurred compared with other like goods, said method comprising:
transmitting information specific to a good from said first location to said remote location;
processing said information to determine whether to authorize returning said good;
comparing said information with prior information from like goods to determine whether a trend exists for returning like goods;
authorizing a return of said good if criteria for returning said good is met;
notifying a user if said trend exists.

14. The method of claim 13 further comprising allocating cost to return said good based on said trend.

15. The method of claim 13 wherein said information comprises information specifically identifying said good, condition of said good, and a reason for returning said good.

16. The method of 13 wherein said information is entered into a computer and is then transmitted to a second computer via a communication network system.

17. The method of claim 16 wherein said second computer comprises a processor for processing said information, comparing said information and authorizing a return.

18. The method of claim 16 wherein said second computer comprises a memory device for storing said information and a database for storing results from comparing said information.

19. The method of claim 13 further comprising reordering a returned product.

20. The method of claim 13 further comprising determining how to return said products.

21. A computerized system for managing returns of goods and collecting and tracking trends identifying reasons for returns of like goods, said system comprising:
information identifying a good being returned including a reason for returning said good and a condition of said good;
an interface medium for entering said information into said system;
a database containing said information based on previous returned like goods;
a processor operable to:
determine whether a good qualifies for return based on said information identifying said good being returned;
compare said information of a good with said information based on previous returned like goods located in said database to determine whether a trend exists as to why like good are returned;
an input/output device to display a message identifying whether a good qualifies for return.

22. The system of claim 21 wherein said input/output device is at a location remote from said processor wherein both locations communicate with each other via a network system.

23. The system of claim 22 further comprising a memory device to store said information.

24. The system of claim 21 further comprising a link to reorder a returned product.

25. The system of claim 21 further comprising a selection option to identify how said good is returned to a manufacture.

26. The system of claim 25 further comprising a calculator to determine a cost for returning said good based on how said good is returned to said manufacture.

27. The system of claim 21 further comprising a second output device for displaying said trend results.

28. The system of claim 26 wherein said cost to return said good is allocated on said trend results.
